(19) United States
(12) Patent Application Publication
(10) Pub. No.: US 2017/0124610 A1
(43) Pub. Date: May 4, 2017

(54) RULES-BASED FOLIO ROUTING

(71) Applicant: Agilysys, Inc., Alpharetta, GA (US)

(72) Inventors: Luke Pfeifer, Renton, WA (US); Larry Steinberg, Sammamish, WA (US); Alessandro Muti, Mercer Island, WA (US); Rehan Jaddi, Sammamish, WA (US)

(21) Appl. No.: 14/929,036

(22) Filed: Oct. 30, 2015

(51) Int. Cl. G06Q 30/04; G06Q 50/12; H04L 29/08

(52) U.S. Cl. CPC G06Q 30/04; H04L 67/12; G06Q 50/12

(57) ABSTRACT

A system and method that routes charges accrued during a hotel stay to folios associated with the stay. The system receives one or more folio routing rules to be applied to a stay, each of which includes a destination folio associated with the stay and criteria for when the rule applies. As charges are accrued, each of the charges are processed by the system by evaluating the charge against the stay's associated folio routing rules. Based on the evaluation, each accrued charge is routed to a folio. Folios, including a listing of routed charges, may then be displayed to users of the system, such as hotel guests and hotel staff. Different folios may present different amounts of information to different types of users. Folios are settled by applying one or more specified payment instruments to the routed charges.

### BACKGROUND

Hotel guests may incur a variety of charges during the course of their hotel stay. For example, in addition to a charge for their room, guests may accrue incidental charges for additional services such as in-room movies, snacks or drinks from an in-room minibar, long distance telephone calls, business center access, fitness center access, meals at hotel restaurants, drinks at hotel bars, and other amenities. In some cases, it may be preferred or required that different charges accrued during a stay be paid for by different parties and/or with different payment methods. For example, a hotel guest may prefer to pay for his room with one credit card, for long distance telephone calls with a second credit card, and for in-room movies with cash. As a further example, a hotel guest may be responsible for incidental charges accrued during his stay while a third-party, such as a travel booking agency or the guest's employer, may be responsible for the room charge.

The manual allocation of different charges to different payment methods, such as by hotel staff during the check-out of a guest, leaves much to be desired. For example, manually allocating charges increases the time required to complete the check-out of a hotel guest. As a further example, there exists a risk of error when manually allocating charges. It would therefore be beneficial to facilitate the ability to allocate charges to different payment methods and/or parties as those charges accrue.

### BRIEF DESCRIPTION OF THE DRAWINGS

FIG. 1 is a diagram of an example environment in which a system for rules-based folio routing of accrued charges may operate.

FIG. 2 is a block diagram of the rules-based folio routing system.

FIG. 3A is a flow diagram of a process for generating folio routing rules associated with a hotel stay.

FIG. 3B is a table of example folio routing rules.

FIG. 4 is a flow diagram of a process for routing charges accrued during a hotel stay to different folios based on associated rules.

FIG. 5 is an example graphical user interface for viewing folios and charges associated with a hotel stay.

FIG. 6 is an example graphical user interface for generating a folio routing rule.

FIG. 7 is an example graphical user interface for charging an item to a hotel stay.

FIGS. 8A and 8B are example graphical user interfaces for viewing scheduled charges associated with a hotel stay.

### DETAILED DESCRIPTION

A system and method to assign charges accrued during a hotel stay to different folios associated with the stay is disclosed herein. Each folio, or list of charges, associated with a stay may have a different payment method and may be configured to expose different information to system users (e.g., not displaying listed charge amounts to the hotel guest). System users include hotel guests, hotel staff, authorized third parties (e.g., employers, travel booking agencies, etc.), and others as described herein. As charges are accrued, each charge is assigned, or routed, to one of the associated folios according to one or more rules applied to the stay based on criteria described herein. Because the rules-based folio routing system routes charges as they are accrued, users of the system may be able to view the accrued charges in the appropriate folios in substantially real-time. Once routed, users of the system may view the charges in a display providing information on the hotel stay, the associated folios, and the charges listed therein. Users of the system may also view information in a printout generated by the system. For example, a hotel guest may receive a printout listing charges associated with the guest's stay from a hotel staff member using the system. Upon completion of the hotel stay (e.g., at check-out), each of the folios are finalized. For example, each charge in a folio may be charged to the payment method corresponding to the folio.

The one or more folio routing rules applied to a stay route the charges accrued during the stay according to aspects of the item or service being charged, the amount being charged, when the charge was accrued, and other criteria as described herein. For example, a first folio routing rule may route all charges from the hotel restaurant charged within a specified date range to a first folio. A second folio routing rule may route all charges exceeding a specified amount to a second folio. A default folio routing rule may route all other charges to a third folio. As described herein, folio routing rules may be generated by a system user in advance of a hotel stay and applied to the hotel stay when the reservation is made. Folio routing rules may be generated during check-in of the hotel guest. And folio routing rules may be generated and applied to the stay over the course of the stay after check-in, which may result in the re-routing of charges already accrued.

Folio routing rules applied to a hotel stay may be applied to the stay on an individual or group basis. Individual rules are associated with a particular individual (e.g., a hotel guest) and may be applied to hotel stays of that particular individual. Group rules are associated with a group and may be applied to the hotel stays of all individuals belonging to or associated with that group. The system may require that group folio routing rules be applied to the hotel stays for all hotel guests belonging to a group. For example, when a hotel guest books a hotel stay through a travel booking agency, group folio routing rules associated with the travel booking agency may be applied to the guest's stay. In another example, when a hotel guest stays at a hotel during work travel, group folio routing rules associated with the guest's employer may be applied to the guest's stay. Group rules may differentiate between different classes of individuals in the group. For example, a corporate group may have a set of rules for executives at the company and a different set of rules for other employees at the company. The group rules would be applied to an individual's stay according to that individual's classification as an executive or as another employee.

Though primarily described with reference to hotel stays, the rules-based folio routing system may be used in other circumstances in which a customer or guest purchases a variety of goods or services from a business associated with travel or the hospitality industry. For example, the system may be used to route different charges associated with travel (e.g., base airfare may route to one folio, and seat upgrade charge may route to another folio), restaurant dining (e.g., alcohol charges may route to one folio, other charges may route to another folio), resorts, spas, casinos, and cruise ships.

Various embodiments of the invention will now be described. The following description provides specific details for a thorough understanding and an enabling description of these embodiments. One skilled in the art will understand, however, that the invention may be practiced without many of these details. Additionally, some well-known structures or features may not be shown or described in detail, so as to avoid unnecessarily obscuring the relevant description of the various embodiments. The terminology used in the description presented below is intended to be interpreted in its broadest reasonable manner, even though it is being used in conjunction with a detailed description of certain specific embodiments of the invention.

### Suitable Environments

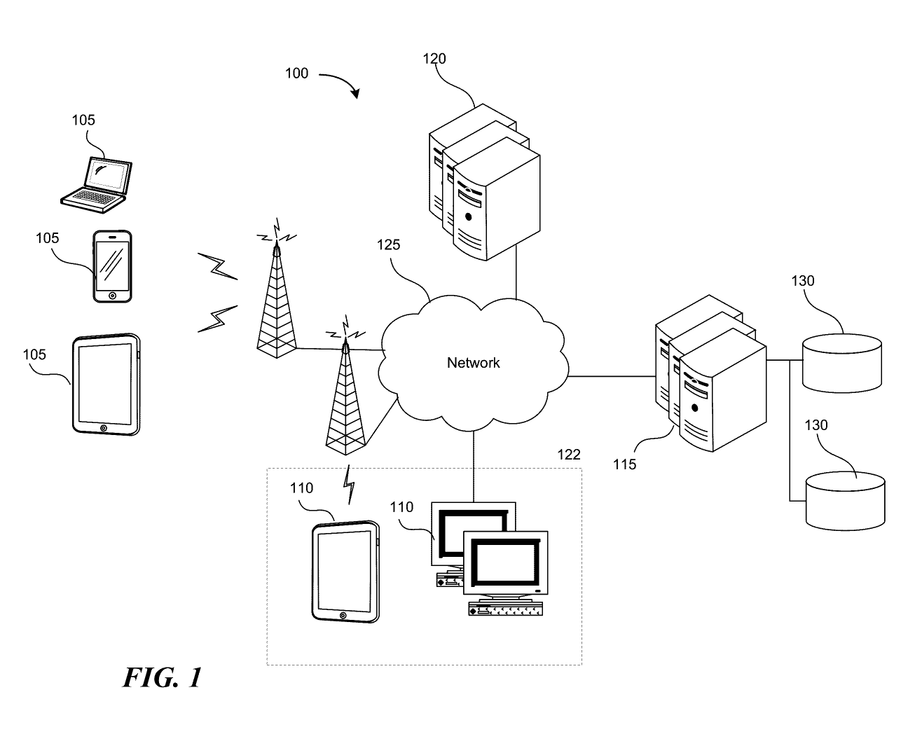

FIG. 1 and the following discussion provide a brief, general description of a suitable environment in which a system to route accrued charges according to routing rules may be implemented. Although not required, aspects of the invention are described in the general context of computer-executable instructions, such as routines executed by a general-purpose computer, a personal computer, a server, or other computing system. The invention can also be embodied in a special purpose computer or data processor that is specifically programmed, configured, or constructed to perform one or more of the computer-executable instructions explained in detail herein. Indeed, the term “computer” and “computing device,” as used generally herein, refer to devices that have a processor and non-transitory memory, like any of the above devices, as well as any data processor or any device capable of communicating with a network. Data processors include programmable general-purpose or special-purpose microprocessors, programmable controllers, application-specific integrated circuits (ASICs), programming logic devices (PLDs), or the like, or a combination of such devices. Computer-executable instructions may be stored in memory, such as random access memory (RAM), read-only memory (ROM), flash memory, or the like, or a combination of such components. Computer-executable instructions may also be stored in one or more storage devices, such as magnetic or optical-based disks, flash memory devices, or any other type of non-volatile storage medium or non-transitory medium for data. Computer-executable instructions may include one or more program modules, which include routines, programs, objects, components, data structures, and so on that perform particular tasks or implement particular abstract data types.

Aspects of the invention can also be practiced in distributed computing environments, where tasks or modules are performed by remote processing devices, which are linked through a communications network, such as a Local Area Network (“LAN”), Wide Area Network (“WAN”), or the Internet. In a distributed computing environment, program modules or subroutines may be located in both local and remote memory storage devices. Aspects of the invention described herein may be stored or distributed on tangible, non-transitory computer-readable media, including magnetic and optically readable and removable computer discs, stored in firmware in chips (e.g., EEPROM chips). Alternatively, aspects of the invention may be distributed electronically over the Internet or over other networks (including wireless networks). Those skilled in the relevant art will recognize that portions of the invention may reside on a server computer, while corresponding portions reside on a client computer.

Referring to the example of FIG. 1, a representative environment 100 in which aspects of the described technology may operate includes one or more customer computing devices 105, staff computing devices 110, and server computers 115 and 120. Staff computing devices 110 are typically associated with a particular property, e.g., a hotel 122, and include point of sale terminals throughout the hotel property. The customer computing device 105 and staff computing devices 110 communicate with each other and the server computers 115 and 120 through networks 125 including, for example, the Internet. The customer computing devices 105 and staff computing devices 110 may communicate wirelessly with a base station or access point using a wireless mobile telephone standard, such as the Global System for Mobile Communication (GSM), or another wireless standard, such as IEEE 8022.11, and the base station or access point communicates with the server computers 115 and 120 via the network 125.

Aspects of the rules-based folio routing system may be practiced by the customer computing devices 105, staff computing devices 110, and server computers 115 and 120. For example, folio routing rules maintained on storage areas 130 may be applied by the server computer 115 to the reservation for a hotel stay. The indication of the hotel reservation may be received from a hotel guest using a customer computing device 105, from a staff member of the hotel using a staff computing device 110, or from a server 120 associated with a third-party, such as a travel booking agency or event planning service. Individual folio routing rules and group folio routing rules may be maintained in different storage areas 130 having different access permissions.

Folio routing rules may be generated by users of the customer computing devices 105 and third-party server computers 120, and communicated to the server computers 115. That is, a hotel guest using a customer computing device 105 may enter criteria through a user interface displayed on the customer computing device, which are used to generate a folio routing rule. As another example, a booking service or corporate events department using a third-party server computer 120 may generate folio routing rules associated with a group of individuals and communicate the group folio routing rules to the server computers 115.

When a guest purchases a good or service in connection with a hotel stay, the purchase information is routed to the server computers 115 which apply folio routing rules to the purchase. Information regarding a purchase may be entered by a staff member of the hotel into a staff computing device 110. For example, a staff member at a hotel restaurant, spa, or gift shop may enter information into a point of sale terminal about goods or services that a guest wants billed to their account. The information entered into the point of sale terminal is automatically routed to the server computers 115 for processing by the system. Information regarding a purchase may also be communicated to the server computers 115 from third-party server computers 120. For example, a hotel guest may purchase an item from a third-party vendor with a concession on a hotel property. The third-party vendor servers would route the occurrence of such a transaction to the server computers 115. Information regarding a purchase may also be automatically routed to the server computers 115. For example, certain minibars in rooms now contain sensors which detect when items are removed from the minibar. Sensors for detecting the removal of an item from the minibar may include pressure sensors placed underneath items, wireless signal sensors (e.g., radio-frequency identification (RFID) readers for detecting the presence of RFID tags attached to items), optical sensors in view of the items, and other sensors through which it may be detected an item has been removed. In that circumstance, an indication of an item that a minibar detects is selected by the guest is automatically routed to the server computers 115. For purposes of this description, “routing” means that the charge is associated with a particular folio so that when the folio is settled, the specified payment instrument or instruments associated with that folio are applied to the charge. Routing may be accomplished by coding, linking, storing, or otherwise constructing an association between the folio and the charge.

After receiving information about purchases, the server computers 115 apply corresponding charges associated with each purchase to the correct folio based on the maintained folio routing rules. Users of the system may then view information regarding accrued charges in each of the folios. For example, a hotel guest may view the folio charges associated with his or her stay through a user interface on customer computing device 105, as may a staff member of a hotel through a user interface on staff computing device 110. The staff member may also edit and finalize charges to the folios. For example, upon checkout a guest may request that all charges in a particular folio be associated with a new payment instrument. In that scenario, the staff member can associate the new payment instrument with the folio.

When displaying folio contents to users, the system may restrict viewing access to certain users. For example, a hotel guest having a first folio that is billed to a personal credit card and a second folio that is billed to an employer may only be allowed to view the charges that are in the first folio. An attempt to view charges generates a request from the customer's computing device 105 to the server computer 115, which returns the contents of requested folios subject to access control rules of the system.

### Suitable System

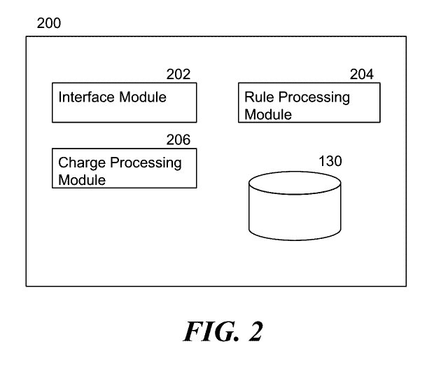

FIG. 2 is a block diagram illustrating a rules-based folio routing system 200. The rules-based folio routing system 200 comprises several modules for processing charges accrued during hotel stays to folios based on folio routing rules. Aspects of the system may be practiced on computing devices operated by hotel guests, computing devices operated by hotel staff, computing devices operated by third-parties (e.g., travel booking agencies and employers of hotel guests), and other computing devices.

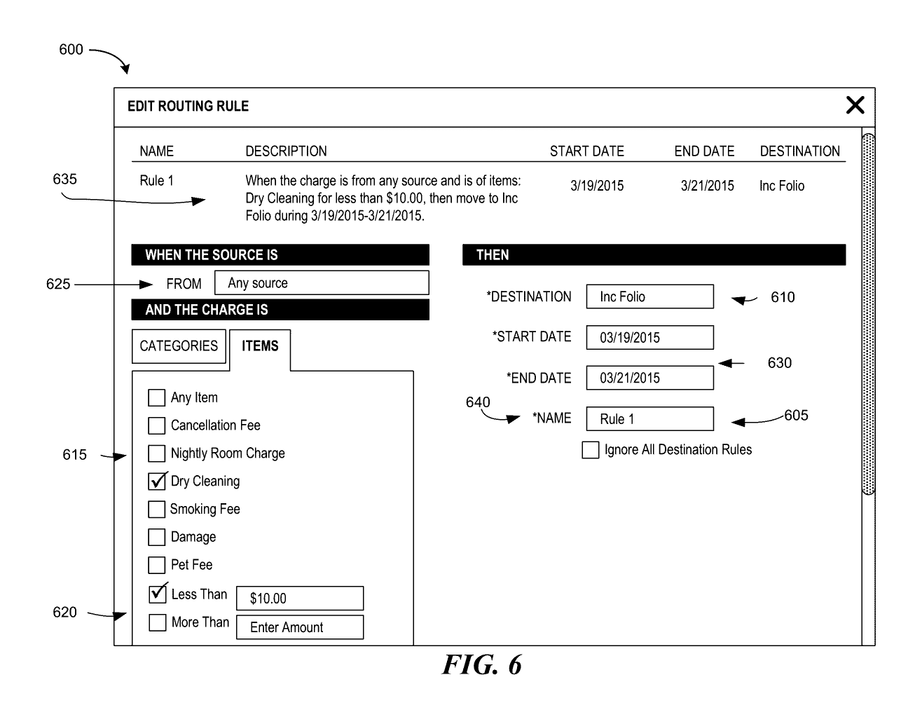

An interface module 202 generates graphical user interfaces (GUIs) to allow users to access the rules-based folio routing system 200. For example, the interface module 202 generates a GUI for viewing each of the folios associated with a hotel stay. The GUI may indicate which payment methods are associated with each folio, and may allow a user to add additional payment methods to a folio or remove existing payment methods. The interface module 202 may also generate a GUI for creating rules specifying to which folios charges accrued during a stay are routed. The GUI may present different criteria (e.g., charge type, source of charge, date of charge, amount of charge, etc.) that may be utilized by a user creating a rule. The user interface module 202 may also generate a GUI for entering a charge and information related to the charge, as well as a GUI for viewing charges, and the folios listing those charges, accrued during a stay. The interface module 202 may generate different GUIs for different users of the system. For example, a listing of charges generated for a hotel guest may not display the amounts of certain charges (for example, when the associated folio is configured to hide charges from the guest) while the listing of charges generated for the hotel staff may list all charge amounts. An example GUI generate by the interface module 202 is depicted in FIG. 6 and described in additional detail herein.

The interface module 202 also provides application programming interfaces (APIs) to enable communication and interfacing with the rules-based folio routing system. APIs may be used by other applications, web portals, or distributed system components to use the system. For example, APIs provided by the interface module 202 may be used to integrate with a third-party vendor that operates a concession at a hotel. As another example, an application operating on a guest mobile device may use an API to interface with system servers and receive current folio information from the system. The API may utilize, for example, Representational State Transfer (REST) architecture and Simple Object Access Protocol (SOAP) protocols.

A rule processing module 204 retrieves folio routing rules and processes charges accrued during a stay according to the applicable folio routing rules, routing the charges to the appropriate folios based on the rules. If no rule applies, the charge may be routed to a default folio associated with the stay. As described herein, individuals and groups (e.g., travel booking agencies, employers, etc.) may provide criteria for how charges should be routed to different folios in the form of folio routing rules. Folio routing rules may be generated in advance of a reservation being made, and may be saved to or otherwise associated with an account belonging to an individual or group. The saved rule may then be associated with an upcoming hotel stay at the time a corresponding hotel reservation is made. Additionally, folio routing rules may be generated after the reservation has been made and during the course of the guest stay. As charges are accrued, and as additional folio routing rules are applied during the guest stay, the rule processing module 204 evaluates the accrued and/or existing charges and determines the appropriate folio for the charges according to the rules.

When evaluating a charge according to applicable folio routing rules, the rule processing module 204 may evaluate the folio routing rules that are applied to a hotel stay in a priority order. For example, the rule processing module may evaluate all group folio routing rules associated with a stay before any individual folio routing rules, such that any group rules for which the rule criteria are met will be applied over any individual routing rules. Each of the folio routing rules may also be associated with a rank, which indicates the priority of that folio routing rule as compared to other folio routing rules within the set of group or individual rules. For example, when evaluating individual folio routing rules applied to a stay, the rule processing module 204 may determine that the criteria of more than one individual folio routing rule is satisfied and will apply the individual rule with the highest rank. A rule's rank may be determined based on the order in which the rule was generated by a user of the system. A rule's rank may also be specified by a system user, such as when the folio routing rule is generated or modified.

The rules processing module 204 may perform cascaded evaluations to route an accrued charge. For example, a folio routing rule may specify a destination account instead of a specific folio to which the charge should be routed. The destination account may be associated with an individual, such as a hotel guest, or a group, such as an employer. When a folio routing rule indicating an account destination is applied by the system, the rules processing module 204 applies the folio routing rules associated with the destination account to route the accrued charge. Continuing with the example above, if a rule being applied has an employer account as its destination, then folio routing rules of the employer are subsequently evaluated to determine the folio to which the accrued charge should be routed. The employer rule may designate a folio as its destination or may designate another account. When the rule designates another account, the rules processing module 204 may continue cascaded evaluations until a destination folio is identified. The rules processing module 204 may however terminate the cascaded evaluation of folio routing rules. For example, an applied rule may designate an account as a destination, and further indicate that any “downstream” rules of the target account should be ignored. The rules processing module 204 would then route the accrued charge to a default folio associated with the target account.

A charge processing module 206 applies specified payment methods to charges accrued during a hotel stay. Each folio associated with a hotel stay corresponds to one or more payment methods (e.g., personal credit card, corporate credit card, direct billing, cash, gift cards, etc.), and each of the charges listed in a folio may be charged to the payment method corresponding to the folio. When a folio has multiple payment methods, the multiple payment methods may be utilized for charges to the folio according to payment parameters. For example, a folio may be configured to charge all charges up to a total dollar amount to a first payment method (e.g., up to $100, up to the value of a stored-value card), and all remaining charges to a second payment method. The folio may also be configured to distribute charges to the different payment methods such that each payment method is charged a set percentage (e.g., 50%) of the total charges to the folio. The charge processing module may be invoked to process any charges before, during, or after the hotel stay. For example, a guest may wish to pay for an accrued charge immediately, without waiting for check-out. The charge processing module would then apply the remaining charges at the conclusion of the hotel stay (e.g., during check-out), and may detect payments that require additional information or assistance from users of the system. The charge processing module may cause the interface module 202 to generate a prompt during the check-out of a hotel guest which may, for example, instruct a hotel staff member that additional information is required from the hotel guest. For example, the hotel guest may need to provide additional information regarding a credit card (e.g., a zip code) before the credit card can be used. As a further example, the prompt may instruct the hotel staff to collect cash to be applied to charges listed in folios for which cash is the corresponding payment method.

The interface module 202, rule processing module 204, and charge processing module 206 access charge data, folio routing rules, guest account data, payment information, system information, and other data maintained in storage areas 130. The accessed data may be stored in any readily-accessible format, including data maintained be a database management system (e.g., MSQL, Microsoft SQL Server, Oracle, MongoDB), or in any relational, non-relational, object, or objection-relational database.

### Flows for a Rules-Based Folio Routing System

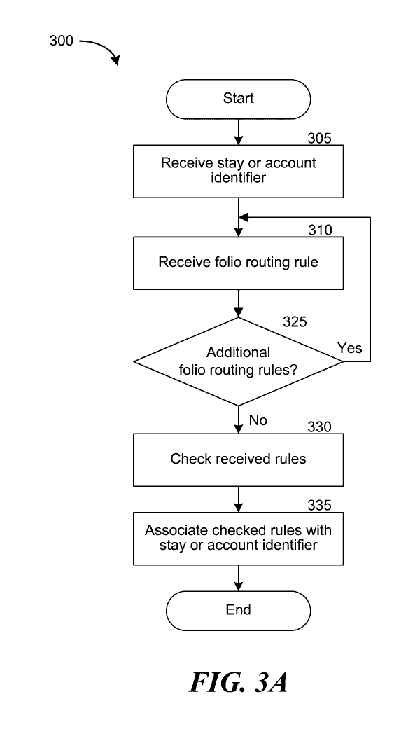

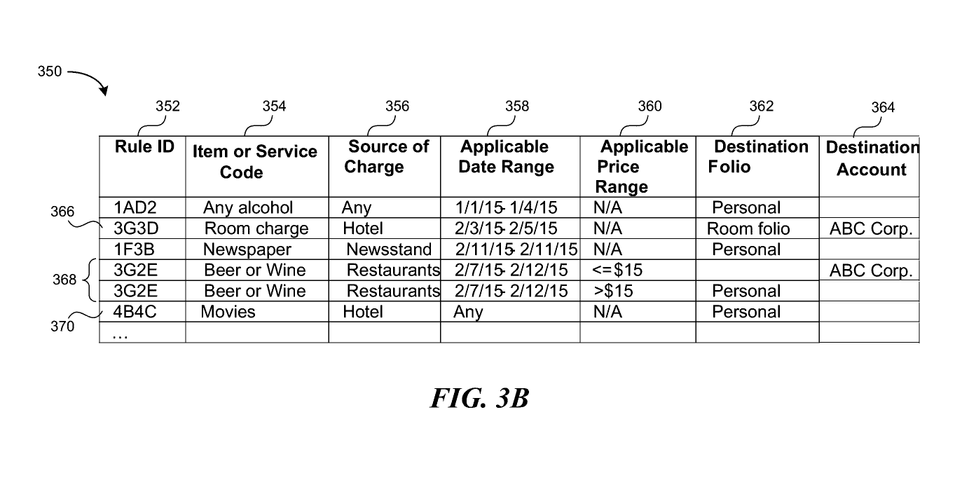

FIG. 3A is a flowchart illustrating an example process 300, implemented by the rules-based folio routing system 200, for receiving one or more folio routing rules and associating the one or more folio routing rules with a hotel stay or with a guest, corporate, or other account for later association with a hotel stay. Each folio routing rule specifies a destination folio to which an accrued charge should be routed when criteria associated with the routing rule are satisfied.

At a block 305, the rules-based folio routing system 200 receives either a stay identifier identifying a hotel stay to which the generated folio routing rules will be applied, or the system receives an account identifier associated with a guest, a group of guests, a business, an agency, or other account. If the system receives a stay identifier that corresponds to a reservation number, the system is able to determine certain information about the stay. For example, the system may be able to determine information regarding the hotel guest (e.g., name, contact information, loyalty rewards information, etc.). The system is also able to determine the location of the hotel stay and the dates of the stay. The system may also be able to determine whether the reservation was made by a third-party (e.g., a travel booking agency) or whether the reservation is for business purposes. The system may also be able to determine an account associated with the stay based on the stay identifier. When the system receives a stay identifier, the received folio routing rules are stored by the system in association with the stay identifier for subsequent application to charges that are incurred during the identified stay. The received folio routing rules may also be stored by the system to the account associated with the stay. In contrast, if the system receives an account number or other identifier corresponding to an individual or group, the received folio routing rules are stored by the system in association with the received account identifier. Once stored in association with the account identifier, the routing rules may then be applied by the system to charges associated with one or more subsequent stays of the guest, group, members of the company, etc.

At a block 310, the system receives a folio routing rule, which includes an indication of a destination folio and a set of criteria that when satisfied will cause an accrued charge to be routed to the destination. The folio routing rule may be entered by a user of the system into a user interface, such as one generated by interface module 202. Criteria for the folio routing rule may specify characteristics of the item being charged as well as when the charge was made. For example, a type of item or service criteria may specify that the folio routing rule applies to charges for one or more of the room charge, cancellation fee, smoking fee, pet fee, dry cleaning charge, long distance charge, charges for room damage, items for purchase in the room, restaurant purchases, alcohol purchases, etc. As a further example, a category of charge criteria may specify that the folio routing rule applies to any good or service falling within a particular category of charge, such as food and beverage charges, room charges, tax charges, and miscellaneous charges. As an additional example, a metadata criteria may specify that the folio routing rule applies to digital purchases whose metadata meet certain parameters (e.g., only movies rated ‘R’). The criteria for the folio routing rule may include the source of the charge. For example, the criteria may specify that the folio routing rule applies to charges from a specific building within a hotel complex, a restaurant within the hotel, a business center within the hotel, a spa within the hotel, etc. The criteria for the folio routing rule may specify a date range during which the charge occurred. The criteria for the folio routing rule may price ranges, such as maximum and minimum charge amounts. Criteria for the folio routing rule may specify a quantity limit. For example, the folio routing rule may specify that only the first purchase of an item is routed according to the rule, such that subsequent purchases of the same item are routed according to a different folio routing rule. And the criteria for the folio routing rule may specify a meal period. For example, purchases at lunch may be routed according to a first folio routing rule, and purchases at dinner may be routed according to a second folio routing rule. Different categories of criteria may be set for different folio routing rules, with different levels of specificity, which enables a user of the system to generate a robust set of rules by which charges accrued during a stay will be evaluated.

Referring to FIG. 3B, some examples of different received folio routing rules are illustrated in table 350. The table 350 includes a rule ID field 352 identifying each listed rule and criteria such as item or service code 354, source of charge 356, applicable date range 358, and applicable price range 360. The table 350 also includes a destination folio field 362 identifying the folio to which charges satisfying the listed criteria should be routed, and a destination account field 364 identifying the account to which charges satisfying the listed criteria should be routed. As described herein, an entry may specify a destination folio, a destination account, or both. When no destination account is listed, the system may default to the account from which the charge was made (or for cascading rule evaluation, the current account being evaluated). For example, the folio routing rule 366 identified by the identifier “3G3D” in the table indicates that the room charge for a guest staying in the hotel from Feb. 2-3, 2015 should be routed to a particular folio (“Room folio”) associated with a corporate account (“ABC Corp.”) that is responsible for the room charge. As another example, the folio routing rule 368 identified by the identifier “3G2E” in the table indicates that any charges less than or equal to $15 for beer or wine at a hotel restaurant from Feb. 7-12, 2015 should be routed to a corporate account (“ABC Corp.”), but any changes greater than $15 for beer or wine at a hotel restaurant during that same date range should be routed to a personal folio. Because the folio routing rule 368 does not specify a destination folio for charges routed to the corporate account, folio routing rules associated with the corporate account may be evaluated to determine the specific destination folio for the charge. As yet another example, the folio routing rule 370 identified by the ID (“4B4C”) is a standing rule from a guest that indicates that any movie the guest ever rents at the hotel property or properties should be billed to a personal folio. It will be appreciated that rules of greater or lesser complexity may be constructed by a system user.

Returning to FIG. 3A, at a decision block 325, the system determines whether there are additional folio routing rules to be associated with the stay or account identifier. For example, through the user interface generated by the interface module 202, a user of the system may indicate that they wish to create another folio routing rule, or alternatively, that they are done. If it is determined that there are additional folio routing rules, processing returns to the block 310. If it is determined that there are no additional folio routing rules, processing continues to a block 330.

At the block 330, the system checks the received folio routing rules. Checks may evaluate the validity of individual folio routing rules. For example, the system may evaluate whether a folio routing rule specifies a date range outside of the date range of a corresponding stay. Checks may also evaluate consistency between the one or more folio routing rules received for a stay or account identifier. For example, the system may evaluate whether a folio routing rule is impossible to apply because of a combination of other previously-specified folio routing rules. If the system identifies a validity or consistency problem with a folio routing rule, it may warn a user through the interface module 202.

After the received rules are checked, processing continues to a block 335, where the checked rules are associated with the either the received stay or account identifier. When the account identifier is a group (e.g., a corporate retreat at a resort), the checked folio routing rules may be associated with the stays of all guests belonging to that group (e.g., all reservations made by the guests that are participating in the retreat).

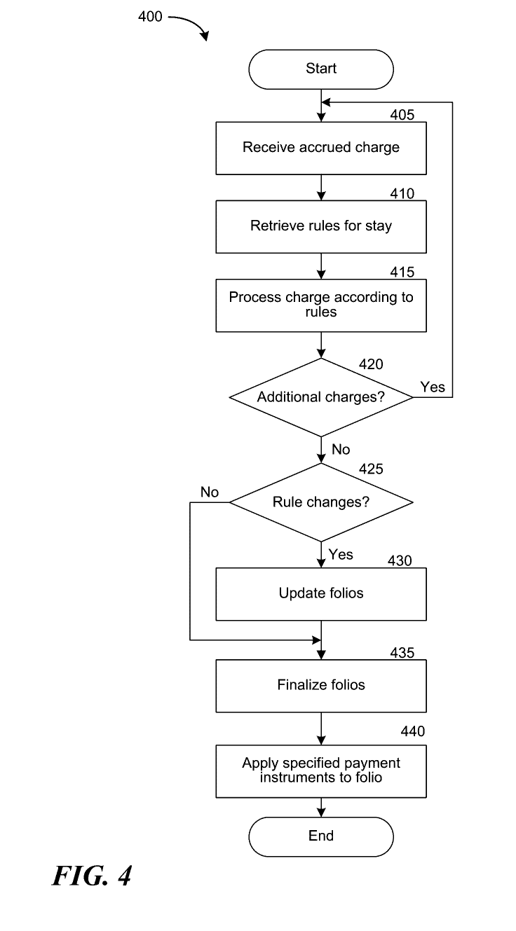

Once folio routing rules have been received by the system, the system may apply the rules to accrued (but not yet paid) or future charges associated with a hotel stay. FIG. 4 is a flowchart illustrating an example process 400, implemented by the rules-based folio routing system 200, for processing charges associated with a hotel stay.

At a block 405, the system receives an indication of an accrued charge. The indication may include the type of item or service being charged, the category of the charge, the amount being charged, the source of the charge, the date of the charge, a description of the charge, and other information that may be used to process the charge. The indication of the accrued charge may be received directly from a point of sale system of the hotel, or may be received after initial processing by back-end financial systems associated with the hotel.

At a block 410, the system retrieves folio routing rules that apply to the stay. As discussed previously, both individual folio routing rules and group folio routing rules may be retrieved. That is, an individual hotel guest may have individual folio routing rules, previously generated by the guest, that are applied to the guest's hotel stay. Additionally or alternatively, the stay may be associated with a group (e.g., the reservation was made through a travel booking agency or for the purpose of corporate travel), and group folio routing rules associated with the group may also be applied to the stay (e.g., rules associated with the travel booking agency or rules associated with an employer, respectively).

At a block 415, the received charge is processed by the system according to the retrieved folio routing rules. As described previously, each folio routing rule includes a destination folio and a set of criteria that specify when the folio routing rule applies. The criteria for each of the folio routing rules are evaluated by the system to determine whether they are satisfied by the received charge. If more than one folio routing rule's criteria is satisfied, then the system may select the folio routing rule that will be applied. For example, if an individual folio routing rule and a group folio routing rule are each satisfied by a charge, the system may elect to apply the group folio routing rule rather than the individual folio routing rule. As a further example, individual and group folio routing rules may each be selected based on a ranking, as described herein. The accrued charge is then routed to the destination folio or destination account associated with the selected folio routing rule.

At a decision block 420, the system determines whether there may be any additional charges accrued for the stay. For example, the determination may be based on whether the stay is still ongoing, or whether the system has received an indication that the stay is ending (e.g., at check-out). If it is determined that there may be additional charges accrued then processing returns to the block 405 where the system waits for additional charges to be accrued. If it is determined that there will be no more accrued charges, then processing continues to a decision block 425.

At the decision block 425, the system determines if there have been any rule changes made during the course of the stay. For example, the individual hotel guest or the group with which the stay is associated may have generated additional rules to be applied to the stay. As a further example, rules previously applied to the stay may been modified (e.g., changes to criteria or changes to the destination folio). If it is determined that no rules have been changed during the stay, processing continues to a block 435. If it is determined that rules did change during the stay, processing continues to a block 430, where the folios associated with the stay are updated according to the changed rules. For example, each of the charges accrued during the stay, or each of the charges accrued prior to the rules change, may be re-processed according to the changed rules. Though FIG. 4 illustrates an example process in which folio updates based on rule changes occur after the system determines no more charges will accrue, the system may also receive indications of when rule changes occur and update folios at that time.

At the block 435, the system finalizes the folios associated with the stay and prepares the folios for settlement. Finalizing the folio may involve re-confirming that all charges have been received, receiving new payment instruments for application to the folio, or otherwise performing accuracy or security checks. At a block 440, the system applies the payment instruments attached to each folio to settle the charges in the folio. The charges are settled by the charge processing module 206, which applies the payment method or methods corresponding to the folio.

### Example User Displays

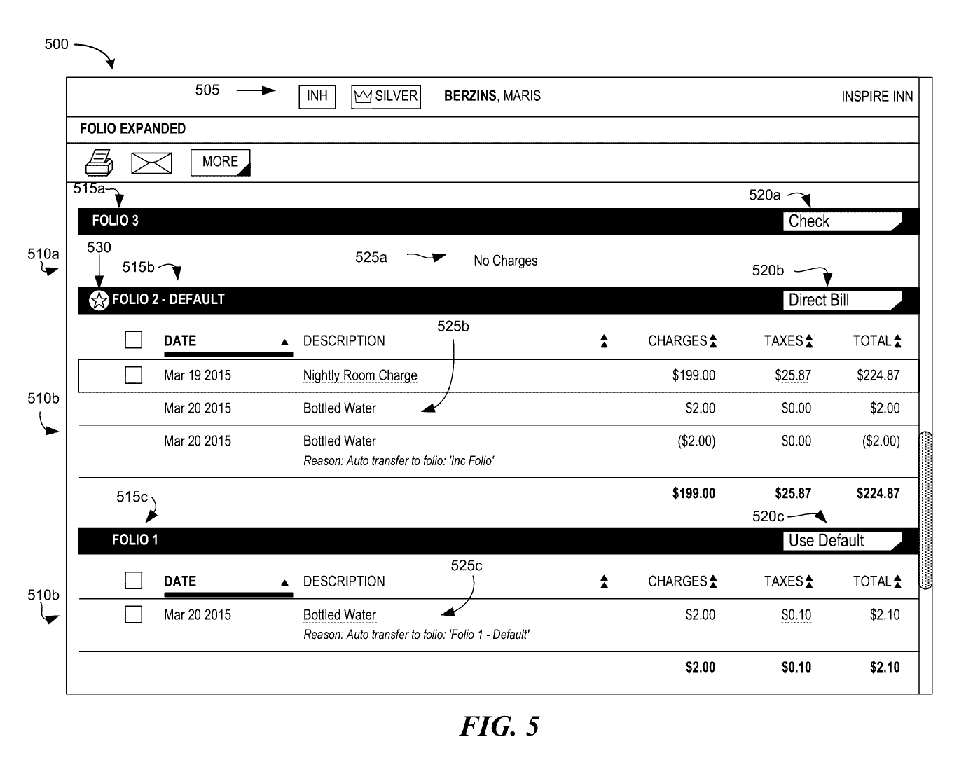

FIGS. 5, 6, 7, 8A, and 8B illustrate example graphical user interfaces 500, 600, 700, 800, such as may be generated by the interface module 202. The depicted interfaces are merely representative of the types of interfaces that may be generated by the system. One skilled in the art will appreciate that various changes can be made to the interfaces in accordance with common design practice. For example, various elements can be added or omitted from the depicted interfaces.

Referring to FIG. 5, a graphical user interface 500 displays folios and accrued charges associated with a hotel stay. The interface includes hotel stay information 505, which indicates the name of the hotel guest, the name of the hotel property, and the dates for the stay. The interface also displays information regarding folios 510a, 510b, and 510c, each of which are associated with the hotel stay. Each folio may be identified by a folio name 515a, 515b, and 515c. Each folio may also correspond to a payment method 520a, 520b, and 520c. For example, payment method 520a indicates payment by check, payment method 520b indicates payment by direct bill, and payment method 520c indicates payment by the default payment method associated with the stay. The interface also includes listings of charges 525a, 525b, and 525c for each folio (if no charge has been routed to the folio, the folio may be blank or empty). Because the rules-based folio routing system processes accrued charges as they are entered into the system, users of the system are able to view the accrued charges in the appropriate folios in substantially real-time. The interface may also indicate via a graphical element or text 530 the default folio associated with the stay.

Referring to FIG. 6, a graphical user interface 600 enables a user to create a folio routing rule associated with a hotel stay or with an individual or group. Through the interface 600 the user may provide the name 605 and the destination folio 610 of the folio routing rule. The user may also provide criteria for the folio routing rule, such as the types of items or services 615, categories of items or services 617, price information 620, the source of the charge 625, and when the charge occurred 630. The interface may also display a summary of the folio routing rule 635. As indicated by graphical element 640, certain criteria or information may be required for a folio routing rule, while other information is optional. The graphical user interface 600 depicts an example in which the tab corresponding to item types is selected, and the interface displays type of items or services 615. When the tab corresponding to categories is selected, the interface displays categories of items or services 617, such as food, beverage, amenity services, etc.

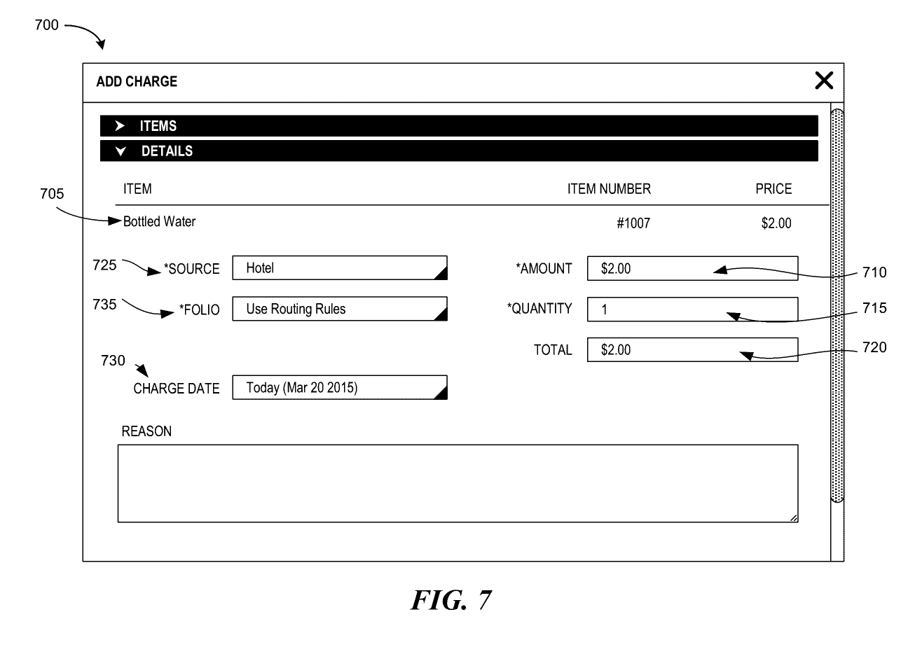

Referring to FIG. 7, a graphical user interface 700 enables a user, such as hotel staff, to charge an item to a hotel stay. Through the interface 700, the user enters details regarding the charge that may be used by the rules-based folio routing system to route the charge to the appropriate folio. For example, a user indicates the item being charged 705, and the amount per item 710 and quantity of the item 715, yielding a total amount 720. The user may also enter the source of the charge 725 (e.g., hotel, hotel restaurant, hotel spa, etc.), the date of the charge 730, and the destination folio of the charge 735. That is, the user may specify the folio to which the charge should be routed, or the user may select a destination option such as “use routing rules,” whereby the charge will be processed by the folio routing rules applied to the stay.

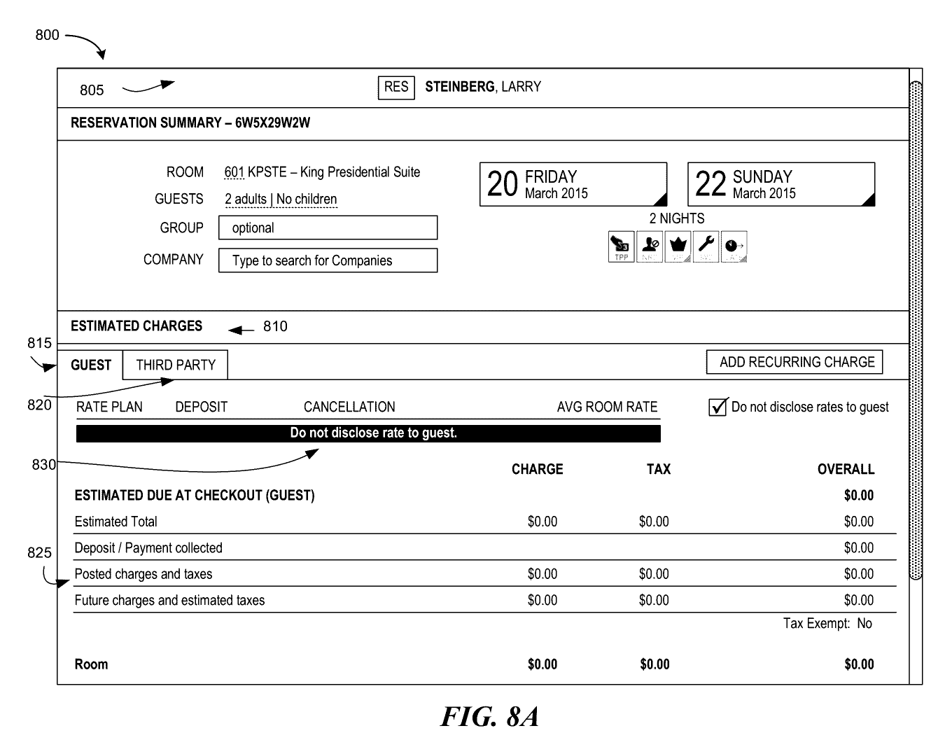

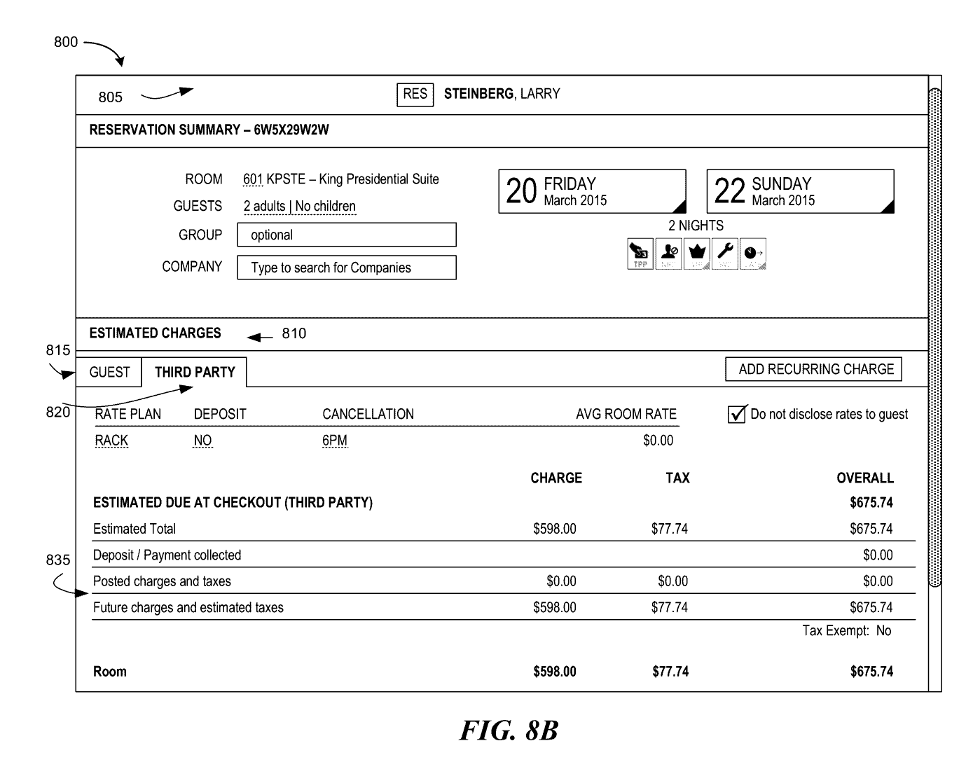

Referring to FIGS. 8A and 8B, graphical user interface 800 enables a user, such as a hotel guest or hotel staff, to view scheduled charges anticipated for a hotel stay. Scheduled charges are those charges that are known in advance. For example, scheduled charges include the room charge and taxes for the room. Though the rules-based folio routing system has been described herein as routing charges as they accrue, the system may also route scheduled charges that are known in advance. As illustrated in FIGS. 8A and 8B, the routing of scheduled charges enables users of the system to see in advance which of the known charges they will be responsible for.

Referring to FIG. 8A, the graphical user interface 800 displays summary information 805 summarizing the hotel stay. Summary information may include the name of the hotel guest, the name of the hotel, and the reservation number of the stay. Summary information may also include the room location, the number of guests, the check-in and check-out dates for the stay, and any hotel perks, status rewards, or additional services associated with the stay. The interface 800 may also include a section for charges 810. The section for viewing charges 810 may further include a tab to view charges to the guest 815 and a tab to view charges assigned to a third-party 820. The display of guest charges and third-party charges may be determined by the folio to which the charges were routed. For example, if a charge was routed to a folio corresponding to payment with the guest's personal credit card, the charge may appear under the guest tab. If a charge was routed to a folio corresponding to payment by a third party (e.g., direct billing to the third party), the charge may appear under the third-party tab. Certain users (e.g., hotel staff) may be able to view both the guest tab 815 and third-party tab 820, while certain users (e.g., hotel guest and third parties) may only be able to view one tab and not the other. The system may enforce such viewing access by requiring log-on information from a user of the system, and assigning certain viewing permissions to the user based on the access rules associated with the class of user.

Still referring to FIG. 8A, when the guest tab 815 is selected guest charges 825 are displayed. As discussed previously, the guest charges 825 include charges in each of the folios for which the guest is responsible for payment. The guest charges display 825 may show no charges to a hotel guest, such as when all charges are to a third party. The guest charges display 825 may also include a warning 830 to not disclose the room rate to a guest. Such a warning may be presented to a hotel staff using the interface 800, and may be generated by the system when a reservation was made by a third party on behalf of the guest, and the third party does not want the guest to be told the room rate actually charged by the hotel (e.g., when a reservation is made through a travel booking agency). The warning may be generated, for example, based on the configuration of the stay or of the folios associated with the stay. Referring to FIG. 8B, when the third-party tab 820 is selected, third-party charges 835 are displayed.

### CONCLUSION

The above Detailed Description of examples of the disclosed technology is not intended to be exhaustive or to limit the disclosed technology to the precise form disclosed above. While specific examples for the disclosed technology are described above for illustrative purposes, various equivalent modifications are possible within the scope of the disclosed technology, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed or implemented in parallel, or may be performed at different times. Further, any specific numbers noted herein are only examples: alternative implementations may employ differing values or ranges.

These and other changes can be made to the disclosed technology in light of the above Detailed Description. While the above description describes certain examples of the disclosed technology, and describes the best mode contemplated, no matter how detailed the above appears in text, the disclosed technology can be practiced in many ways. Details of the system may vary considerably in its specific implementation, while still being encompassed by the technology disclosed herein. As noted above, particular terminology used when describing certain features or aspects of the disclosed technology should not be taken to imply that the terminology is being redefined herein to be restricted to any specific characteristics, features, or aspects of the disclosed technology with which that terminology is associated. In general, the terms used in the following claims should not be construed to limit the disclosed technology to the specific examples disclosed in the specification, unless the above Detailed Description section explicitly defines such terms.

I/we claim:

1. A method in a hospitality billing system for processing accrued charges, the method comprising:
receiving, at a hospitality billing system, a plurality of charges accrued during a facility stay, wherein each charge comprises an indication of a type of good or service and one or more attributes of the charge;
retrieving, at the hospitality billing system, one or more routing rules associated with the facility stay, wherein each routing rule comprises a destination folio and one or more criteria;
assigning each of the received charges to destination folios associated with the facility stay by:
evaluating whether the charge satisfies a routing rule based on the type of good or service, attributes of the charge, and the routing rule criteria; and
assigning the charge to the routing rule destination folio based on the evaluation; and
processing each of the received charges based on a payment method associated with the destination folio to which the charge was assigned.

2. The method of claim 1, wherein the attributes of a charge comprises an amount being charged, a date on which the charge occurred, or a source of the charge.

3. The method of claim 1, wherein each of the routing rules is associated with a rank, and wherein assigning each of the received charges to a folio further comprises:
evaluating whether the charge satisfies a second routing rule based on the attributes of the charge and the second routing rule criteria,
and wherein the charge is assigned based on the evaluation of the routing rule, the evaluation of the second routing rule, and the ranks associated with the routing rule and the second routing rule.

4. The method of claim 1, wherein at least one of the received charges is assigned to a destination folio when the charge is incurred.

5. The method of claim 1, wherein at least one of the received charges is assigned to a destination folio when the facility stay ends.

6. The method of claim 1, further comprising presenting on a display an assigned charge or presenting through an application programming interface the assigned charge.

7. The method of claim 6, further comprising limiting the presentation of certain assigned charges depending on a type of user of the hospitality billing system.

8. The method of claim 1, further comprising:
prior to processing each of the received charges, receiving an indication that the routing rule associated with the facility stay has been modified; and
re-assigning at least one of the received charges to destination folios based on the modified routing rule.

9. The method of claim 1, wherein at least one of the routing rules is associated with an individual guest and wherein at least one of the routing rules is associated with a group of guests.

10. The method of claim 1, wherein a payment method associated with a destination portfolio may comprise one or more of cash, check, debit bill, credit bill, gift card, or direct bill.

11. The method of claim 1, wherein the type of good or service is specified as a category of good or service.

12. A non-transitory computer-readable medium encoded with instructions that, when executed by a processor, perform a method in a hospitality billing system for processing accrued charges, the method comprising:
receiving, at a hospitality billing system, a plurality of charges accrued during a facility stay, wherein each charge comprises an indication of a type of good or service and one or more attributes of the charge;
retrieving, at the hospitality billing system, one or more routing rules associated with the facility stay, wherein each routing rule comprises a destination folio and one or more criteria;
assigning each of the received charges to destination folios associated with the facility stay by:
evaluating whether the charge satisfies a routing rule based on the type of good or service, attributes of the charge, and the routing rule criteria; and
assigning the charge to the routing rule destination folio based on the evaluation; and
processing each of the received charges based on a payment method associated with the destination folio to which the charge was assigned.

13. The non-transitory computer-readable medium of claim 12, wherein the attributes of a charge comprises an amount being charged, a date on which the charge occurred, or a source of the charge.

14. The non-transitory computer-readable medium of claim 12, wherein each of the routing rules is associated with a rank, and wherein assigning each of the received charges to a destination folio further comprises:
evaluating whether the charge satisfies a second routing rule based on the attributes of the charge and the second routing rule criteria,
and wherein the charge is assigned based on the evaluation of the routing rule, the evaluation of the second routing rule, and the ranks associated with the routing rule and the second routing rule.

15. The non-transitory computer-readable medium of claim 12, further encoded with instructions that when executed by the processor perform the method in the hospitality billing system for processing accrued charges, the method further comprising:
prior to processing each of the received charges, receiving an indication the routing rule associated with the facility stay has been modified; and
re-assigning at least one of the received charges to destination folios based on the modified routing rule.

16. The non-transitory computer-readable medium of claim 12, wherein at least one of the routing rules is associated with an individual guest and wherein at least one of the routing rules is associated with a group of guests.

17. The non-transitory computer-readable medium of claim 12, wherein at least one of the received charges is assigned to a destination folio when the charge accrued.

18. A system including at least one processor and memory to process accrued charges in a hospitality billing system, the system comprising:
a rule processing module configured to:
receive, at a hospitality billing system, a plurality of charges accrued during a facility stay, wherein each charge comprises an indication of a type of good or service and one or more attributes of the charge;
retrieve, at the hospitality billing system, one or more routing rules associated with the facility stay, wherein each routing rule comprises a destination folio and one or more criteria; and
assign each of the received charges to destination folios associated with the facility stay by:
evaluating whether the charge satisfies a routing rule based on the type of good or service, attributes of the charge, and the routing rule criteria; and
assigning the charge to the routing rule destination folio based on the evaluation; and
a charge processing module configured to:
process each of the received charges based on a payment method associated with the destination folio to which the charge was assigned.

19. The system of claim 18, further comprising:
an interface module configured to:
present, on a display, an assigned charge, or
provide, through an application programming interface, the destination folio to which a charge was assigned.

20. The system of claim 18, wherein the interface module is further configured to limit the display of certain assigned charges depending on a type of user of the hospitality billing system.
